(19) United States
(12) Patent Application Publication
(10) Pub. No.: US 2003/0020567 A1
(43) Pub. Date: Jan. 30, 2003

(54) Planar filters having periodic electromagnetic bandgap substrates

(76) Inventors: William Johnson Chappell, Lafayette, IN (US); Linda P.B. Katehi, Zionsville, IN (US); Matthew Patrick Little, Natick, MA (US)

Correspondence Address: YOUNG & BASILE, P.C., Suite 624, 3001 West Big Beaver Road, Troy, MI, 48084-3107, US

(21) Appl. No.: 10/171,300

(22) Filed: Jun. 12, 2002

Related U.S. Application Data
(60) Provisional application No. 60/297,526, filed on Jun. 13, 2001.

(51) Int. Cl. H01P 1/203

(52) U.S. Cl. 333/204

(57) ABSTRACT

The concept of electromagnetic bandgaps (EBG) is used to develop a high quality filter that can be integrated monolithically with other components due to a reduced height, planar design. Coupling adjacent defect elements in a periodic lattice creates a filter characterized by ease of fabrication, high-Q performance, high port isolation and integrability to planar or 3-D circuit architectures. The filter proof of concept has been demonstrated in a metallodielectric lattice. The measured and simulated results of 2, 3 and 6 pole filters are presented at 10.7 GHz, along with the equivalent circuits.

### RELATED APPLICATIONS

This application claims the benefit of provisional application No. 60/297,526 which was filed on Jun. 13, 2001.

### STATEMENT REGARDING FEDERALLY SPONSORED RESEARCH OR DEVELOPMENT

The US Government may have a paid-up license in this invention and the right in limited circumstances to require the patent owner to license others on reasonable terms as provided for by the contract No. DAAH04-96-1-0377 by Low-Power Electronics, MURI.

### FIELD OF THE INVENTION

The present invention relates to planar filters having periodic electromagnetic bandgap (EBG) substrates.

### BACKGROUND OF THE INVENTION

An EBG substrate, which is coated with metal on both sides creating a parallel plate, is either periodically loaded with metal or dielectric rods. For use of metallic inclusions, the substrate, is loaded with metallic rods, effectively creating a high pass, two-dimensional filter that blocks energy from propagating in the substrate from DC to an upper cutoff. This form of arrangement is termed a metallo-dielectric EBG (also termed Photonic Bandgap or PBG). For dielectric inclusions, a two dimensional band stop affect is created within the periodic material. This form of periodic substrate is termed a two dimensional dielectric EBG.

An EBG defect resonator is made by intentionally interrupting the otherwise periodic lattice. The defect localizes energy within the lattice and a resonance is created. A single defect resonator has been shown to provide high Qs, which make this resonator a good candidate for a sharp bandwidth, low insertion loss filters.

### SUMMARY OF THE INVENTION

Using the concept of a constant coupling coefficient filter, a defect resonator is used to develop multipole filters. These filters exhibit excellent insertion loss and isolation due to the high Q exhibited by the Electromagnetic Bandgap (EBG) defect resonators. The fabrication of these filters requires nothing more than simple via apertures on a single substrate plane and, in addition the planar nature of these filters makes the filters amenable to 3-D circuit applications. Finally, since the EBG substrate prohibits substrate modes, the isolation between the input and output ports of the filter can be much greater than that of other planar architectures. Two, three, and six pole 2.7% filters were measured and simulated, with measured results showing insertion losses of −1.23, −1.55, and −3.28 dB respectively. The out of band isolation was measured to be −32, −46, and −82 dB 650 MHZ away from the center frequency (6% off center) for the three filters.

Other applications of the present invention will become apparent to those skilled in the art when the following description of the best mode contemplated for practicing the invention is read in conjunction with the accompanying drawings.

### BRIEF DESCRIPTION OF THE DRAWINGS

The description herein makes reference to the accompanying drawings wherein like reference numerals refer to like parts throughout the several views, and wherein:

FIG. 1A is a composite view of a dimensional bonded circuit concept with 2-pole filtering substrate layer;

FIG. 1B is an exploded view of a dimensional bonded circuit concept with 2-pole filtering substrate layer;

FIG. 2A is a two-pole simulation and electric field plot of coupled defects whose S-parameters indicate the interresonator coupling;

FIG. 2B is a schematic representation of two defects adjacent to one another used to generate the graph of FIG. 2A;

FIG. 2C is a graphic representation of the electric field generated with respect to FIG. 2A and 2B;

FIG. 3 is a graph for a 2-pole filter comparing FEM simulation with actual measurements;

FIG. 4 is a graph for a 3-pole filter comparing FEM simulation with actual measurements; and

FIG. 5 is a graph for a six-pole filter comparing optimized equivalent circuit, fall wave simulation, and actual measurements.

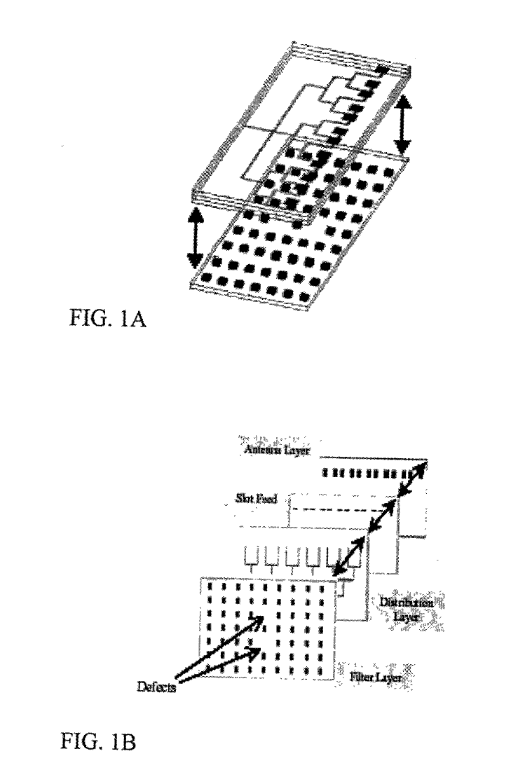

### DESCRIPTION OF THE PREFERRED EMBODIMENT

The present invention focuses on the extension of a single metallo-dielectric resonator to multiple coupled defects. The coupled defects properly arranged create a multipole filter.

As opposed to half wave, microstrip or CPW resonators, the Q of the defect becomes larger with an electrically thicker substrate. The EBG architecture is of significant practical relevance because the architecture produces a relatively high Q planer resonator by merely using via apertures in the substrate, which makes the filter amenable to planar fabrication techniques.

To fully exploit the defect resonators for the development of a multipole filter, the equivalent circuit is required. Using the Ansoft HFSS commercial simulator, a FEM simulation of two shorted CPW lines weakly coupled through a single resonator was used to determine the numerical values of the R, L, and C elements of the equivalent shunt resonator. From the peaked frequency response, the unloaded Q and the capacitance of the resonator can be determined. The unloaded Q is extracted by running a simulation with intentionally designed weak coupling and extracting the value from the magnitude of the transmission through the formula:

$${Q}_{u n l o a d e d} = \frac{{Q}_{L o a d e d}}{( 1 - {S}_{21} )} = \frac{[ \frac{{f}_{0}}{{f}_{1} - {f}_{2}} ]}{( 1 - {S}_{21} )} \qquad ( 1.1 )$$

where f₁ and f₂ are the frequencies at 3 dB below the peak resonant frequency transmission at f₀. The capacitance is extracted by the phase of the weakly coupled reflection response, through the following equation:

$${( C = \frac{1}{2} \frac{ⅆ B}{ⅆ ω} \vert )}_{ω = {ω}_{0}} \qquad ( 1.2 )$$

where B is the imaginary part of the admittance of the resonator deembedded to the end of the coupling line. With the unloaded Q and the capacitance, the rest of the shunt resonator parameters can be obtained using the classic formulas:

$$\begin{matrix}L = \frac{1}{{ω}^{2} C} & ( 1.3 ) \\ R = {Q}_{U N L O A D E D} * ω * L & ( 1.4 )\end{matrix}$$

As a result the parameters of the building block from which the rest of the filter is constructed can be obtained.

For a narrowband filter, the insertion loss for a given out of band isolation is optimal when the coupling between the resonators is constant. By implementing defect resonators adjacent to each other without otherwise perturbing that lattice, the coupling between the individual resonators will be constant for each stage and therefore optimal for insertion loss versus isolation. If desired, the coupling parameters may be adjusted, however, by slightly perturbing the lattice between the resonators, to achieve more complex filter shapes.

In an illustrative example, one can start from the low pass, lumped element prototype, using the low pass filter parameters

G₀=G₁=G₂=. . . Gₙ=1

As standard in filter development, these low pass parameters can then be transformed into the band-pass equivalent circuit parameters using a low-pass to band-pass transformation. The transformed parameters can be related to the physical parameters of each resonator as detailed in the following section.

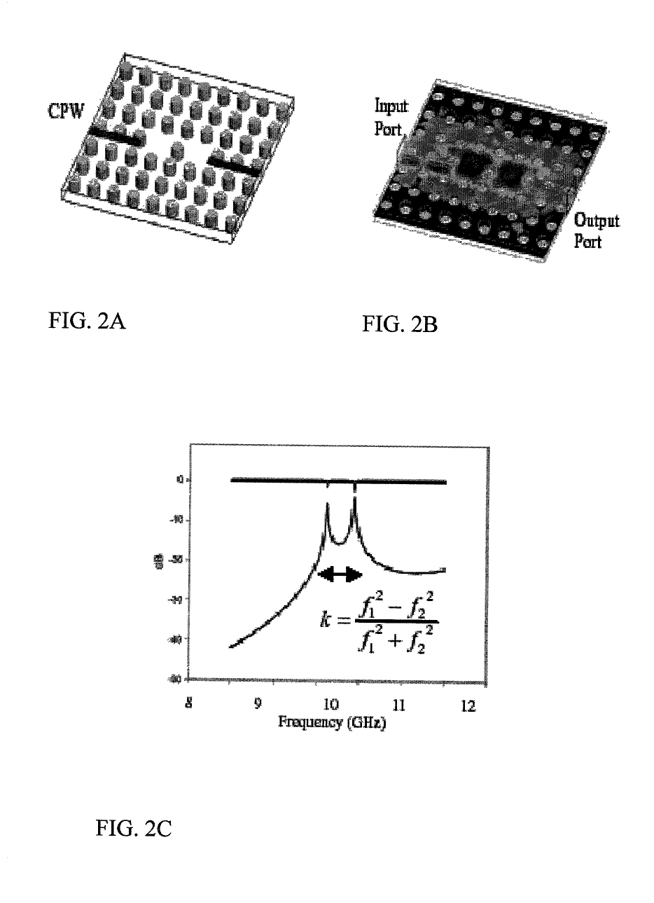

The fields within a single defect resonator evanesce into the surrounding periodic lattice and are not strictly localized within the defect region. When two defects are implemented adjacent to each other (as in FIG. 2), the fields in the defects couple. As the defects couple to each other, the central frequency peak of the single resonator separates into two distinct peaks. The amount that the peaks veer from the natural resonant frequency is a measure of the coupling coefficient. Therefore, FIG. 2 shows a graphical means to obtain the coupling coefficient between resonators. In order to discern distinct peaks in the transmission response, weak coupling to the defects is simulated. The coupling coefficient can then be obtained, which can be related to the low-pass prototype values, by the following relations

$$k = \frac{{f}_{1}^{2} - {f}_{2}^{2}}{{f}_{1}^{2} + {f}_{2}^{2}} = \frac{B W}{ω} \sqrt{\frac{1}{{G}_{j} {G}_{j + 1}}} \qquad ( 1.5 )$$

where f₁ and f₂ are the frequencies of the peaks in S₂₁, while Gⱼ, ω, and BW are the low pass element value, the low pass equivalent cutoff and filter bandwidth, respectively.

The location of a defect in relation to the evanescent fields from an adjacent defect resonator determines the coupling. The more lattice elements that separate the defects from each other, the weaker the coupling. In addition the sharper that the fields evanesce outside of each resonator, the less the coupling is for a given resonator separation. The shape, size, and period of the periodic inclusions control the amount of confinement of the resonant fields and as a result control the coupling. The coupling is decreased by designing the resonant frequency deeper within the bandgap region (i.e. a resonant frequency with sharper field attenuation into the surrounding lattice) and by increasing the separation between the resonators.

The sidewalls of the metallodielectric resonator may be interpreted as a high pass two-dimensional spatial filter with many periodic short evanescent sections. The rejection of the high pass filter created by the evanescent sections defines the confinement of the fields, and therefore the coupling between adjacent resonators. This rejection is determined by the spacing between the rods that make up the short evanescent sections. The further apart the metal surfaces of the vias that define the sidewalls of the resonators are from each other, the less the field surrounding the defect region evanesces. Therefore by decreasing the size of the radius of the rod or by increasing the lattice period, the coupling increases. The fields inside resonators made from rods large in size relative to the lattice period are very tightly confined to the resonator.

In the equivalent circuit of the present filter, the shunt resonators that represent the defect are separated by a traditional J-inverter. This J-inverter controls the coupling between the shunt resonators and is therefore representative of the sidewalls that surround the defect. To determine the numerical values of the equivalent circuit for the J-inverter, a tee junction of three inductors is assumed. A circuit optimizer was used to determine the numerical values of the coupling inductances by matching the peak separation found from the full wave simulation of two weakly coupled resonators.

In addition, the external coupling must be determined and controlled. The external coupling (Qₑ) controls the overall insertion loss and ripple in a multipole filter. The desired external coupling for the given coupled resonators is given as:

$${Q}_{e} = \frac{{G}_{0} {G}_{1 ω}}{B W} = \frac{ω}{B W} \qquad ( 1.6 )$$

where the variables are the same as defined in previous sections. This external coupling can be extracted using simulated values of a single defect resonator. The coupling mechanism may be altered resulting in a changed loaded Q (Q₁) of the system. Since the unloaded Q (Qᵤ) of the resonator has already been obtained for a single resonator, the external Q can be extracted from the relation:

$$\frac{1}{{Q}_{1}} = \frac{1}{{Q}_{u}} + \frac{1}{{Q}_{e}} \qquad ( 1.7 )$$

A simulation on a single resonator provides the 3 dB width for a given coupling scheme and therefore extracts the loaded Q value, which in turn determines the external Q.

For the metallodielectric filter described herein, a CPW line is used to provide the necessary external coupling as shown in FIG. 2. The CPW line is fed through the metallic lattice, probing into the defect cavity. The further the CPW line probes into the cavity, the lower the value of the external Q. If the external Q is too high, then distinct peaks are observed as large ripples in the transmission response. For this undercoupled case, the CPW line should be moved further into the cavity to lower the external Q. The equivalent circuit for the external coupling portion of the filter is a traditional impedance transformer. The turns ratio of the transformer is determined by the strength of the coupling to the first defect, and therefore is determined by the distance the CPW line impinges into the defect region. The impedance transformer may be quantified by considering the simulation of a single resonator and is inherently related to the external Q.

Using the concepts described above, a prototype filter was developed out of Duroid 5880, εᵣ=2.2, loss tan=0.0009. The filter was chosen to have a center frequency at 10.7 GHz with approximately a 2.7 percent bandwidth. A single pole simulation, which takes less than an hour on a standard 400 MHZ Pentium III computer, was run using Ansoft HFSS, to determine the center frequency. Using a two-pole simulation (˜1 hour run time), the diameter of the rods and the lattice period were adjusted to provide the correct coupling coefficients to provide the desired 2.7% bandwidth. Then, the length of the CPW line was adjusted to critically couple the filter to provide minimum insertion loss.

The resulting lattice has a transverse period of 9 mm, longitudinal period of 7 mm, and rod radius of 2 mm. For a substrate height of 120 mils, the unloaded Q of this resonator is ˜750. For critical coupling for these rod spacings, the CPW line is shorted 3 mm into the first and last defect.

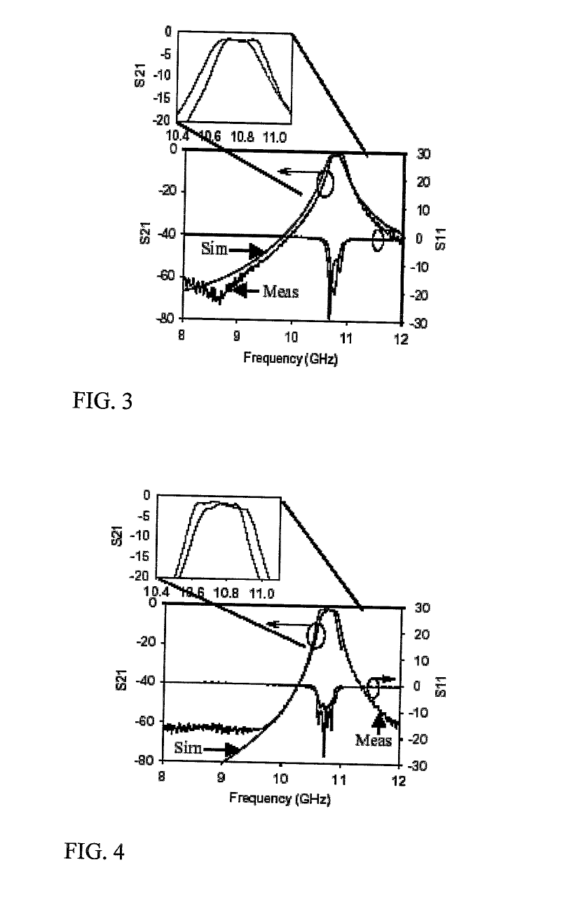

These same parameters were used in cascaded stages to create multiple pole filters. A three pole and a six-pole filter were developed with the goal of an optimal insertion loss relative to a maximum out of bandwidth isolation. The results can be seen in the plots of FIGS. 3, 4, and 5. Also, these results can be numerically compared in the table below.

| | CENTER | | BAND- | ISOLATION | |
|---|---|---|---|---|---|
| | FREQUENCY | INSERTION | WIDTH | 7% OFF | |
| FILTER | (GHz) | LOSS (dB) | (GHz) | CENTER | |
| 2-Pole Sim | 10.727 | −1.37 | 0.263 | −32 | dB |
| 2-Pole Meas | 10.787 | −1.23 | 0.265 | −30 | dB |
| 3-Pole Sim | 10.73 | −1.32 | 0.290 | −42 | dB |
| 3-Pole Meas | 10.797 | −1.56 | 0.293 | −45 | dB |
| 6-Pole Sim | 10.725 | −3.26 | 0.279 | >−100 | dB |
| 6-Pole Meas | 10.8275 | −3.28 | 0.257 | −80 | dB |

The measurements and simulation compare favorably. The resonant frequency agrees within 1% in all cases (0.5% in the two pole filter, 0.7% for the three pole filter, and 0.8% in the six pole filter). The slight shift in frequency is due to the fact that the FEM model used cannot accurately model complete circles and must approximate circles as polygons. Therefore the vias were simulated slightly different than what was measured. The bandwidth is nearly exact for the 2 and 3 pole filters (<1% difference) but is 23 MMZ less for the measured six-pole filter. The difference in bandwidth for the six-pole filter is the result of the hand placement of the feed lines relative to the lattice of vias. Due to the misalignment, the measured filter is not exactly critically coupled. The outside poles in the measured response is so weakly coupled that it does not factor in the pass band bandwidth. Also evident in the comparison is the increased ripple in the pass band of the measured filters. The ripple is also caused by weak external coupling to the filters. The out of band isolation was excellent, due to the fact that the substrate does not support substrate modes. For the six-pole filter, the transmission reached the noise floor 4.3% away from the center frequency. The out of band isolation is limited by the space wave coupling of the CPW lines, which can be eliminated by packaging the CPW lines, placing a reflective boundary or absorber between the ports, or fabricating the CPW lines on opposite sides of the substrate. Note that the measured results were achieved without tuning any of the parameters.

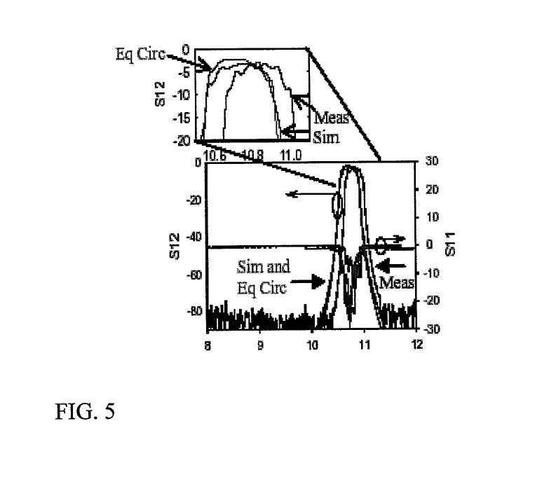

An equivalent circuit was extracted using one and two pole simulations and the procedures explained above. The values for the equivalent shunt resonator are: C=53 pF, Lᵣₑₛ34. 13 pH and R=209 ohms. Note that the values are for the resonator after being transformed through the shorted CPW line transition. There are not unique solutions for these values and the values relative to the transformers were found to be L_{coup}=0.25 nH and n=1.9 respectively. The single resonator and the coupling inverter were then cascaded to form multipole filters. The results of the cascaded 6-pole filter are shown in FIG. 5 in comparison with the full-wave simulation and measured results. The correlation between the equivalent circuit and the measured and simulated values is quite similar. However, the insertion loss for the equivalent circuit is −2.3 dB. The theoretical optimum is 1 dB less than what is simulated and measured. This optimum value, however, does not account for losses in the feed lines and connectors unlike the simulated and measured results. In addition, the difference is in part due to the measured and simulated filters not being exactly critically coupled. Through the use of the equivalent circuit, rapid adjustments to the filter may be made. Also, physical insight and the theoretical limits of the filter may be obtained.

In conclusion, a relatively simple, high-Q filter was measured, simulated, and analyzed with good agreement and without the need for tuning. High isolation was obtained since substrate noise is eliminated using the properties of the EBG substrate. A low insertion loss was obtained due to the low loss nature of the resonators. The performance is superior to what could be obtained in other planar architectures. The EBG/via aperture architecture makes these filters amenable to planar circuit integration. More advanced geometries and materials are expected to make these filters smaller with even better performance in future applications.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A planar filter comprising:
a substrate having a periodic lattice defined by sidewalls spaced from one another with a plurality of inclusions extending therebetween in a substantially uniform geometric pattern and at least two defects in the pattern coupled in proximity to one another in the periodic lattice, each defect defining an enlarged cavity resulting from at least one missing inclusion; and
at least one external line extending through the lattice and projecting into a region associated with the cavity of one of the defects.

2. The filter of claim 1 wherein the substrate further comprises:
an electromagnetic bandgap substrate coated with metal on both sides creating a parallel plate periodically loaded with inclusions.

3. The filter of claim 1 wherein the inclusions further comprise metallic rods.

4. The filter of claim 1 wherein the inclusions further comprise dielectric rods.

5. The filter of claim 1 wherein the at least two defects intentionally interrupt the periodic lattice to form multiple coupled defects therein to create a multipole filter.

6. The filter of claim 5 wherein the coupled defects are constant.

7. The filter of claim 1 wherein the at least two defects are implemented adjacent to one another for coupling fields in the defects.

8. The filter of claim 7 wherein a central frequency peak of a single resonator is separated into distinct peaks as the at least two defects couple to each other.

9. The filter of claim 1 wherein a location of a defect in relation to an evanescent field from an adjacent defect resonator determines a coupling field of the defects.

10. The filter of claim 1 wherein additional incursions in the periodic lattice separating the at least two defects from each other weaken a coupling field of the defects.

11. The filter of claim 1 wherein a coupling field of the at least two defects for a given resonator separation is less when the coupling field sharply evanescents outside of each resonator.

12. The filter of claim 1 wherein a shape, a size, and a period of inclusions within the periodic lattice control an amount of confinement of resonant fields, and as a result control a coupling field of the defects.

13. The filter of claim 1 wherein a coupling field is decreased by providing a resonant frequency deeper within a bandgap region and by increasing the separation between the resonators.

14. The filter of claim 1 wherein the coupling field is decreased by providing a resonant frequency with sharper field attenuation in the surrounding lattice.

15. The filter of claim 1 further comprising:
a metallodielectric resonator defining a high pass two-dimensional spatial filter with many periodic short evanescent sections.

16. The filter of claim 15 further comprising:
the evanescent sections creating a rejection of the high pass filter and a coupling between adjacent resonators.

17. The filter of claim 16 further comprising:
the rejection determined by a spacing between the inclusions forming the short evanescent sections.

18. The filter of claim 17 wherein increasing the spacing between the metal surfaces forming vias defining the sidewalls of the resonators decreases evanescence of a field surrounding a region of the at least two defect.

19. The filter of claim 1 wherein decreasing a dimensional size of the inclusion increases the coupling field of the defects.

20. The filter of claim 1 wherein increasing a period of the periodic lattice increases the coupling field of the defects.

21. The filter of claim I wherein fields associated with resonators having inclusions with large dimensions relative to a period of the periodic lattice are very tightly confined to the corresponding resonator.

22. The filter of claim 1 further comprising:
a reflective barrier located between an input port and an output port.

23. The filter of claim 1 further comprising:
the external lines fabricated on opposite sides of the substrate.
